(19) United States
(12) Patent Application Publication
(10) Pub. No.: US 2012/0181987 A1
(43) Pub. Date: Jul. 19, 2012

(54) SYSTEM FOR CHARGE AND DISCHARGE OF BATTERY PACK

(75) Inventors: Sangyoung Lee, Yongin-si (KR); Jihoon Kim, Yongin-si (KR)

(73) Assignee: Samsung SDI Co., Ltd., Yongin-si (KR)

(21) Appl. No.: 13/349,428

(22) Filed: Jan. 12, 2012

(30) Foreign Application Priority Data
Jan. 17, 2011 (KR) 10-2011-0004441

(51) Int. Cl. H02J 7/00

(52) U.S. Cl. 320/128

(57) ABSTRACT

A system configured to charge and discharge a battery pack is disclosed. The system includes a battery management unit configured to receive a wake up voltage, and a wake up unit configured to apply the wake up voltage to the first port during normal operation.

### CROSS-REFERENCE TO RELATED APPLICATIONS

This application claims priority to and the benefit of Korean Patent Application No. 10-2011-0004441, filed on Jan. 17, 2011, the entire content of which is incorporated herein by reference.

### BACKGROUND

1. Field

The disclosed technology relates to a system for charging and discharging a battery pack.

2. Description of the Related Technology

Along with advances of portable electronic devices such as cellular phones, notebook computers, camcorders, and personal digital assistants (PDAs), secondary batteries have been actively researched.

The rechargeable battery is generally manufactured as a battery pack having multiple battery cells and a charge/discharge circuit. Charging and discharging a battery cell is performed with an external power source or an external load through an external terminal in the battery pack. When the external power source is connected to the battery pack through the external terminal, the battery cell is charged by power supplied through the external terminal and the charge/discharge circuit from the external power source. When the external load is connected to the battery pack through the external terminal, the battery cell is discharged by power supplied through the external terminal and the charge/discharge circuit to the external load. The charge/discharge circuit controls the charging and discharging of the battery. The charge/discharge circuit is generally controlled by a battery management unit (BMU), and the BMU operates according to the power supplied from the battery cell.

### SUMMARY OF CERTAIN INVENTIVE ASPECTS

One inventive aspect is a system configured to charge and discharge a battery pack. The system includes a battery management unit with a first port configured to receive a wake up voltage, and a second port configured to output a control voltage, where the battery management unit is configured to control charging and discharging of the battery pack. The system also includes a wake up unit configured to apply the wake up voltage to the first port. The wake up unit includes a first transistor including a control electrode, a first electrode connected to a positive terminal of the battery, and a second electrode connected to the first port of the battery management unit. The wake up unit also includes a second transistor including a control electrode connected to the second port of the battery management unit, a first electrode connected to the ground, and a second electrode connected to the control electrode of the first transistor.

Another inventive aspect is a system configured to charge and discharge a battery pack. The system includes a battery management unit with a first port configured to receive a wake up voltage, and a second port configured to output a control voltage, where the battery management unit is configured to control charging and discharging of the battery pack. The system also includes a wake up unit configured to apply the wake up voltage to the first port. The wake up unit includes a first transistor including a first electrode connected to the first port of the battery management unit, a second electrode connected to a positive electrode terminal of the battery, and a control electrode. The wake up unit also includes a second transistor including a first electrode connected to the ground, a second electrode connected to the control electrode of the first transistor, and a control electrode connected to the second port of the battery management unit.

Another inventive aspect is a system configured to charge and discharge a battery pack. The system includes a battery management unit with a first port configured to receive a wake up voltage, where the battery management unit is configured to control charging and discharging of the battery pack. The system also includes a wake up unit configured to apply the wake up voltage to the first port, where the wake up unit includes a diode connected between a positive electrode terminal of the battery and the first port.

### BRIEF DESCRIPTION OF THE DRAWINGS

FIG. 1 is a block diagram of a battery pack according to an embodiment.

FIG. 2 is a block diagram of a battery management unit and a wake up unit in the battery pack shown in FIG. 1.

FIG. 3A is a schematic diagram illustrating a circuit for measuring current consumed by the wake up unit of the battery pack shown in FIG. 1, and FIG. 3B is a simulation result of the circuit of FIG. 3A.

FIG. 4 is a block diagram of a wake up unit in a charge and discharge system of a battery pack according to another embodiment.

FIG. 5A is a graph illustrating the operation of a charge and discharge system according to another embodiment, and FIG. 5B is a graph illustrating the current flowing through a second transistor shown in FIG. 5A.

FIG. 6 is a block diagram of a charge and discharge system in a battery pack according to still another embodiment.

### DETAILED DESCRIPTION OF CERTAIN INVENTIVE EMBODIMENTS

Hereinafter, certain embodiments are described in detail with reference to the accompanying drawings. A system for charging and discharging a battery pack according to certain embodiments are described.

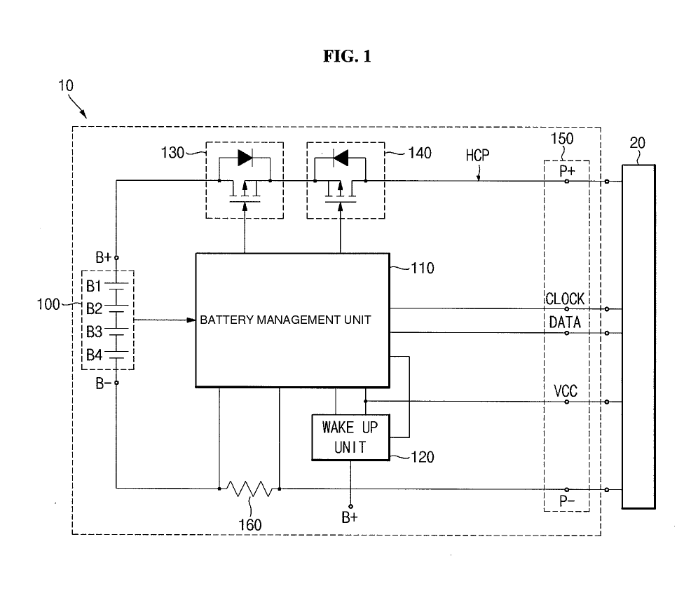

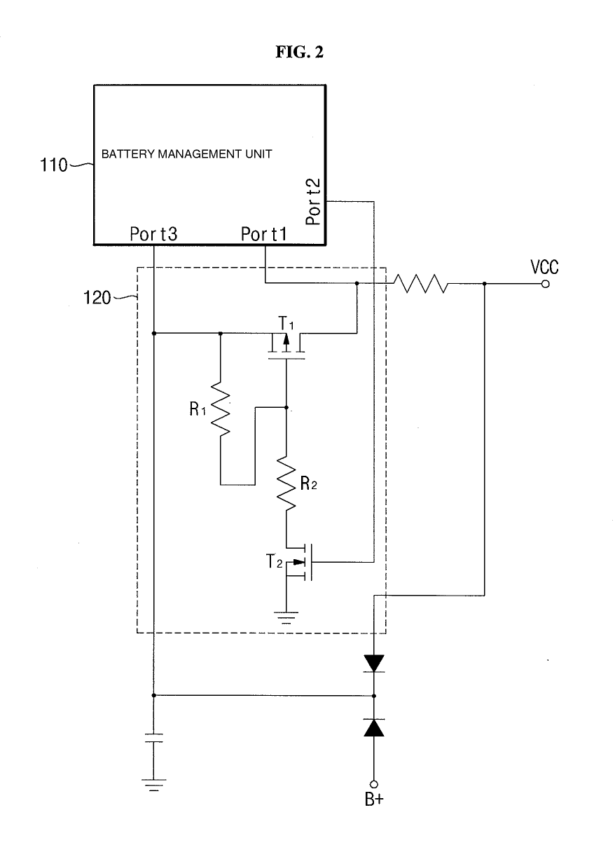

FIG. 1 is a block diagram of a battery pack 10 according to an embodiment, and FIG. 2 is a block diagram of a battery management unit (BMU) 110 and a wake up unit 120 in the battery pack 10 shown in FIG. 1. Referring to FIG. 1, the battery pack 10 comprises a battery 100, a battery management unit (BMU) 110, a wake up unit 120, a charging element 130, a discharging element 140, a connector 150, and a sensor resistor 160.

The battery pack 10 is connected to a charger 20 through the connector 150 to charge the battery 100. Alternatively, the battery pack 10 may be connected to an external load, such as a cellular phone or a portable notebook computer, through the connector 150 to provide power to the external load by discharging the battery 100.

A high current path (HCP) between the battery 100 and the connector 150 is used as a charge/discharge path, and a relatively large amount of current flows through the HCP. A power terminal of the charger 20 or the external load 20 may be connected to a first pack terminal P+ or a second pack terminal P− of the connector 150, and a communication terminal of the charger 20 may be connected to a communication terminal CLOCK or DATA of the connector 150.

The battery 100 may comprise one or more unit battery cells B1, B2, B3, and B4, and may be charged or discharged to a constant voltage. In FIG. 1, B+ and B− indicate electrode terminals, and represent a positive electrode B+ and a negative electrode terminal B− of each of the unit battery cells B1, B2, B3, and B4 connected in series, respectively. The number of unit battery cells of the battery 100 may differ depending on, for example, the capacitor required by the external load.

The charge and discharge system of the illustrated battery pack may comprise a BMU 110 and a wake up unit 120. In general, a BMU is driven by receiving power from a battery. When the voltage supplied from the battery drops to less than a predetermined level, the BMU enters into a shutdown mode and stops driving. In such a case, to be woken up, the BMU receives a wake-up voltage exceeding the predetermined level from a charger through an auxiliary power terminal VCC of the connector 150. The BMU receives power from the charger through the auxiliary power terminal VCC. However, if electrostatic discharge (ESD) is externally applied through the connector of the battery pack, even when the power supplied to the BMU is not less than the predetermined level, the BMU may erroneously enter into a shutdown mode.

Hereinafter, embodiments of a charge and discharge system capable of using the BMU while protecting the BMU even when the BMU erroneously enters into a shutdown mode is described. The BMU 110 controls charging and discharging of the battery 100 by detecting a voltage of the battery 100 and controlling operation of the charging element 130 and the discharging element 140. For example, when the battery pack 100 is connected to the charger 20 through the connector 150, the BMU 110 sets the charging element 130 to an on state and the discharging element 140 to an off state, thereby charging the battery 100. In addition, when the battery pack 100 is connected to the external load 20, the BMU 110 sets the charging element 130 to an off state and the discharging element 140 to an on state, thereby discharging the battery 100. Although not shown, the BMU 110 is capable of detecting voltages of the respective unit battery cells B1, B2, B3 and B4.

The BMU 110 may comprise a plurality of input/output ports. The following description focuses on ports characterizing the charge and discharge system according to the illustrated embodiment. The BMU 110 comprises a first port Port1, a second port Port2, and a third port Port3, as shown in FIG. 2.

The first port Port1 receives a wake-up voltage. Accordingly, the BMU 110 may be woken up when a voltage exceeding a predetermined threshold level is applied to the BMU 110 through the first port Port1. In addition, the first port Port1 may be electrically connected to the auxiliary power terminal VCC of the connector 150 to receive auxiliary power from the outside through the auxiliary power terminal VCC when the power is not supplied from the battery 100. The second port Port2 continuously outputs a predetermined level of voltage. The third port Port3 allows the BMU 110 to apply power. The third port Port3 may be electrically connected to the positive electrode terminal B+ to receive power. The third port Port3 may also be connected to the auxiliary power terminal VCC to receive power from the charger 20.

As shown in FIG. 2, the wake up unit 120 comprises a first transistor T1, a first resistor R1, a second transistor T₂, and a second resistor R2. The first transistor T1 comprises a first electrode, a second electrode and a control electrode. The first electrode of the first transistor T1 is electrically connected to a positive electrode terminal B+ of the battery 100. The second electrode of the first transistor T1 is electrically connected to the first port Port1 of the BMU 110. The first transistor T1 may be a p-type metal oxide semiconductor field effect transistor (MOSFET).

The first resistor R1 comprises a first terminal and a second terminal. The first terminal of the first resistor R1 is electrically connected to the first electrode of the first transistor T1. The second terminal of the first resistor R1 is electrically connected to the control electrode of the first transistor T1.

The second resistor R2 comprises a first terminal and a second terminal. The first terminal of the second resistor R2 is electrically connected to the control electrode of the first transistor T1 and the second terminal of the first resistor R1. The second terminal of the second resistor R2 is electrically connected to the second electrode of the second transistor T₂.

The second transistor T₂ comprises a first electrode, a second electrode and a control electrode. The first electrode of the second transistor T₂ is electrically connected to the ground. The second electrode of the second transistor T₂ is electrically connected to the second terminal of the second resistor R2. The control electrode of the second transistor T₂ is electrically connected to the second port Port2 of the BMU 110. The second transistor T₂ may be an n-type MOSFET.

The charging element 130 and the discharging element 140 are connected along the HCP established between the battery 100 and the connector 150 and are used when charging and discharging the battery 100. The charging element 130 may be a field effect transistor (to be referred to as an FET1) and a parasitic diode (to be referred to as a D1). The discharging element 140 may be a field effect transistor (to be referred to as an FET2) and a parasitic diode (to be referred to as a D2). The source and drain of the FET1 are oriented in a direction opposite to that of the FET2. With this configuration, the FET1 limits the flow of current from the connector 150 to the battery 100. The FET2 is connected to limit the flow of current from the battery 100 to the connector 150. The D1 and D2 are configured to allow the current to flow in a direction opposite to the direction in which the current is limited.

The connector 150 is connected to the battery 100 and serves as a terminal for charging the battery 100 when connected to the charger 20 during charging, and as a terminal for discharging of the battery 100 when connected to the external load 20 during discharging. The connector 150 comprise a first pack terminal P+ and a second pack terminal P−. The first pack terminal P+ is a positive electrode pack terminal connected to the positive electrode terminal B+ of the battery 100. The second pack terminal P− is a negative electrode pack terminal connected to the negative electrode terminal B− of the battery 100. When the charger 20 is connected to the connector 150, charging from the charger 20 to the battery 100 is performed. When the external load 20 is connected to the connector 150, discharging from the battery 100 to the external load 20 is performed.

In addition, the connector 150 comprises an auxiliary power terminal VCC. When the voltage of the battery 100 is less than the wake-up voltage of the BMU 110, the auxiliary power terminal VCC provides a path for supplying auxiliary power from the charger 20 to the BMU 110. The wake-up voltage is the minimum voltage required to drive the BMU 110. In addition, the auxiliary power terminal VCC may serve to supply power from the charger 20 when the charger 20 is connected to the battery pack 10 through the connector 150.

The connector 150 further comprises communication terminals CLOCK and DATA connected to the BMU 110. The communication terminals CLOCK and DATA comprise a clock terminal CLOCK and a data terminal DATA. When the charger 20 is connected to the connector 150, the communication terminals CLOCK and DATA allow for communication between the BMU 110 and the charger 20. For example, the communication terminals CLOCK and DATA may transmit voltage information of the battery 100 or charging control information from the BMU 110 to the charger 20.

The sensor resistor 160 is connected along the HCP established between the battery 100 and the connector 150. As shown, the sensor resistor 160 is connected between the negative electrode terminal B− and the second pack terminal P− of the battery 100. In addition, the sensor resistor 160 is connected to the BMU 110. Accordingly, the sensor resistor 160 allows the BMU 110 to identify charge or discharge current by sensing the voltage difference across the sensor resistor 160 given the resistance value of the sensor resistor 160. Thus, the sensor resistor 160 transmits information on the charge current or discharge current of the battery 100 to the BMU 110.

Charging and discharging a battery pack according to an embodiment is described with reference to FIG. 2.

The BMU 110 receives power from the positive electrode terminal B+ of the battery 100 through the third port Port3. In such a state, the BMU 110 may output a constant voltage through the second port Port2. Here, the voltage output through the second port Port2 may be a DC voltage having a predetermined level. In this case, the voltage is applied to the control electrode of the second transistor T₂, thereby turning the second transistor T₂ on.

Because the second transistor T₂ is turned on, the control electrode of the first transistor T₁ is electrically connected to the ground. Here, since the first transistor T₁ is a p-MOSFET, it is turned on. Because the first transistor T₁ is turned on, the positive electrode terminal B+ of the battery 100 and the first port Port1 of the BMU 110 connected through the first transistor T. Accordingly, the voltage of the battery 100 is applied to the first port Port1 of the BMU 110 through the first transistor T₁. The voltage applied to the first port Port1 has a level enough to wake up the BMU 110. Since a constant voltage is always output through the second port Port2, a wake-up voltage can be continuously supplied to the first port Port1 of the BMU 110 by the wake up unit 120.

Because the voltage is continuously applied to the first port Port1, power consumption may increase. Here, the first resistor R₁ and the second resistor R₂ are connected to the first transistor T₁ and the second transistor T₂, thereby reducing the power consumption when the constant voltage is applied to the first port Port1. Since the first resistor R₁ and the second resistor R₂ have sufficiently high resistance values, the power consumption can be minimized.

As described above, the charge and discharge system according to the illustrated embodiment can prevent the battery pack from erroneously shutting down by applying the wake-up voltage to the first port Port1 all the time. Because the wake-up voltage is applied to the first port Port1, the BMU 110 does not enter the shut down mode, even if exposed to an ESD event.

As shown, the wake up unit 120 distributes the voltage of the positive electrode terminal B+ of the battery 100 using transistors and resistors. The distributed voltage may be used as the power supply of the BMU 110 and as the wake-up voltage applied to the first port Port1. Therefore, when the power supplied is less than a predetermined level due to the discharging of the battery 100, the level of voltage applied to the first port Port1 also decreases, thereby preventing the first port Port1 from waking up in a proper shutdown mode.

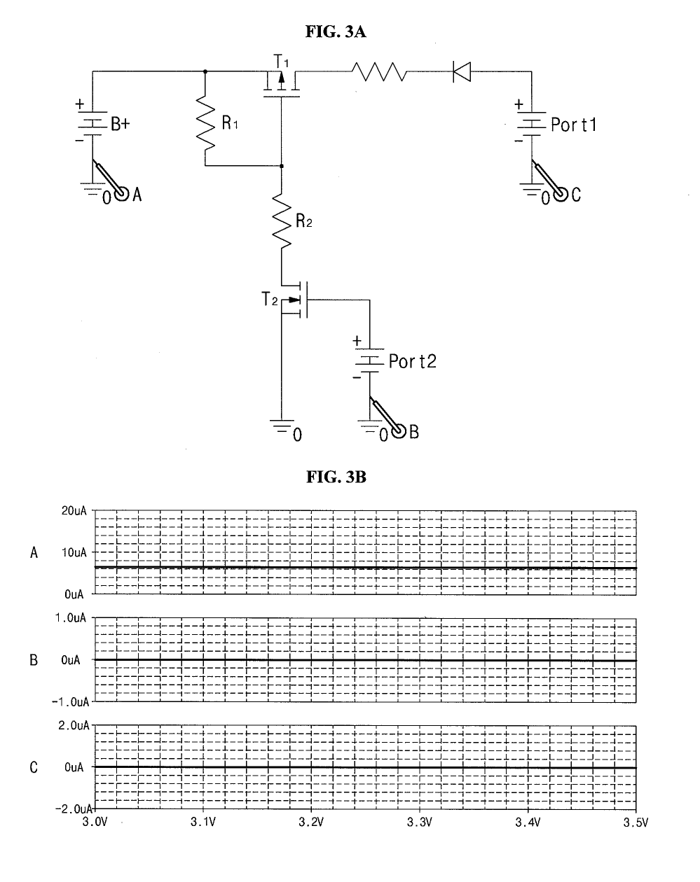

FIG. 3A is a schematic diagram illustrating a circuit for measuring current consumed by the wake up unit of the battery pack shown in FIG. 1. In the measurement, voltages of the positive electrode terminal B+ of the battery 100 the first port Port1 and the second port Port2 are set to 18 Vdc, 10 Vdc and 3 Vdc, respectively.

FIG. 3B is a simulation result of FIG. 3A, in which the graphical representation A indicates current consumption measured at the positive electrode terminal B+ of the battery 100, the graphical representation B indicates current consumption measured at the second port Port2 of the BMU 110, and the graphical representation C indicates additional current consumption measured at the first port Port1. As confirmed from the simulation result shown in FIG. 3B, the wake up unit 120 increases current consumption by approximately 6 μA.

Hereinafter, a charge and discharge system of a battery pack according to another embodiment is described. The charge and discharge system according to the illustrated embodiment is different from the charge and discharge system according to the previous embodiment in view of the signal output from a second port of a BMU and the configuration of a wake up unit. The following description focuses on the signal output from a second port of the BMU and the configuration of the wake up unit.

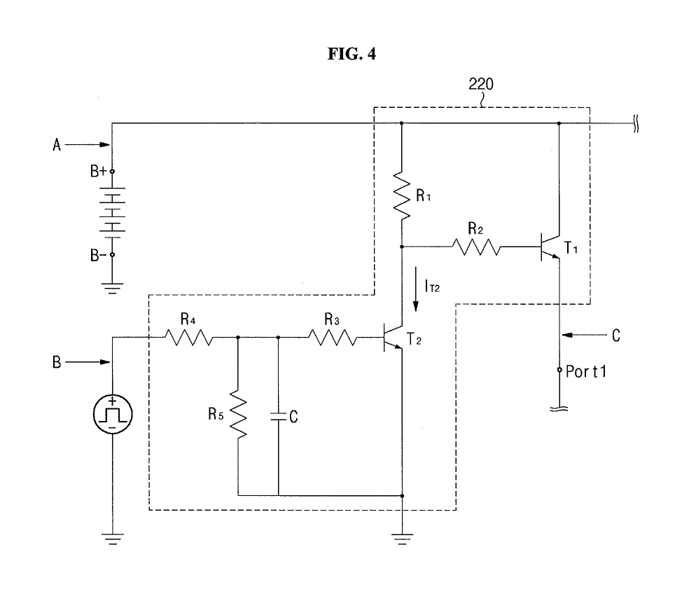

FIG. 4 is a block diagram of a wake up unit in a charge and discharge system of a battery pack according to another embodiment. Referring to FIG. 4, the charge and discharge system comprises a BMU (not shown) and a wake up unit 220. The BMU (not shown) will later be described with reference to the BMU 110 shown in FIG. 2. The wake up unit 220 comprises a first transistor T₁, a second transistor T₂, first to fifth resistors R₁, R₂, R₃, R₄ and R₅ and a capacitor C.

The first transistor T₁ comprises a first electrode, a second electrode and a control electrode. The first electrode of the first transistor T₁ is electrically connected to the first port Port1 of the BMU 110. The second electrode of the first transistor T₁ is electrically connected to the positive electrode terminal B+ of the battery 100. The first transistor T₁ comprises a bipolar junction transistor (BJT).

The first resistor R₁ comprises a first terminal and a second terminal. The first terminal of the first resistor R₁ is electrically connected to the second electrode of the first transistor T₁. The second resistor R₂ comprises a first terminal and a second terminal. The first terminal of the second resistor R₂ is electrically connected to the second terminal of the first resistor R₁. The second terminal of the second resistor R₂ is electrically connected to the control electrode of the first transistor T₁.

The second transistor T₂ comprises a first electrode, a second electrode and a control electrode. The first electrode of the second transistor T₂ is electrically connected to the ground. The second electrode of the second transistor T₂ is electrically connected to the second terminal of the first resistor R1 and the first terminal of the second resistor R₂. The second transistor T₂ comprises a bipolar junction transistor (BJT).

The third resistor R₃ comprises a first terminal and a second terminal. The first terminal of the third resistor R₃ is electrically connected to the control electrode of the second transistor T₂. The fourth resistor R₄ comprises a first terminal and a second terminal. The first terminal of the fourth resistor R₄ is electrically connected to the second terminal of the third resistor R₃. The second terminal of the fourth resistor R₄ is electrically connected to the second port Port2 of the BMU 110. The fifth resistor R₅ and the capacitor C are connected in parallel between the third resistor R₃ and the fourth resistor R₄ and the ground. For example, the fifth resistor R₅ may be connected between a first terminal of the fourth resistor R₄ and the ground, and the capacitor C may be connected between the second terminal of the third resistor R₃ and the ground.

Unlike the embodiment shown in FIG. 2, in the embodiment of FIG. 4, a periodically constant signal is output from the second port Port2 of the BMU 110. For example, the output signal of the second port Port2 may be a square wave signal. In addition, the square wave signal may have a voltage level enough to turn the second transistor T₂ on during a ‘high’ period.

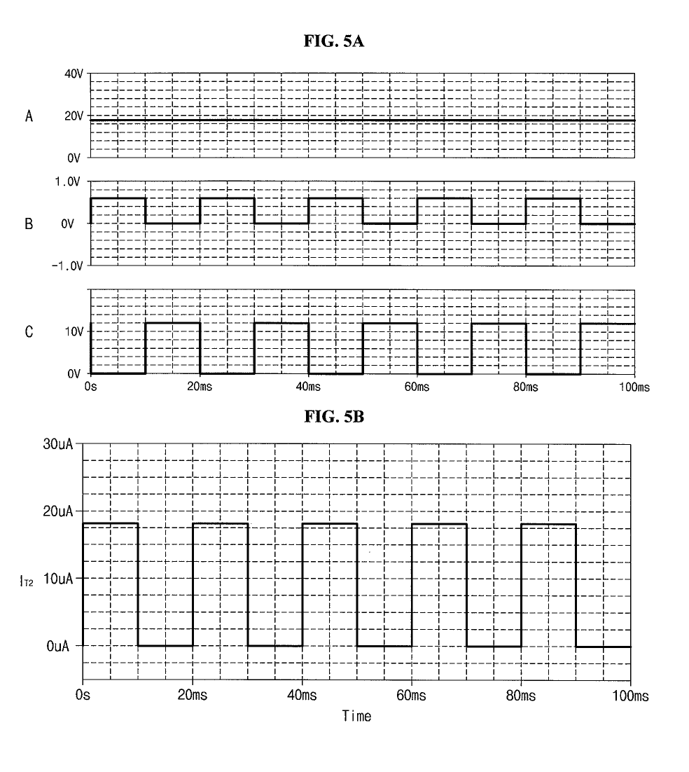

Hereinafter, the operation of the charge and discharge system of a battery pack according to the embodiment of FIG. 4 is described. FIG. 5A is a graph illustrating the operation, and FIG. 5B is a graph illustrating the current (I_{T2}) flowing through the second transistor (T₂).

Constant power voltage of approximately 18 V is supplied to the BMU 110 through the positive electrode terminal B+ of the battery 100. In addition, a voltage of approximately 0.6 V may first be output during a period of approximately 10 ms through the second port Port2 of the BMU 110. Accordingly, the second transistor T₂ is turned on. Here, most of the current flowing through the wake up unit 220 flows to the ground through the first resistor R₁ and the second transistor T₂. As shown in FIG. 5B, the current I_{T2} flowing through the second transistor T₂ may be approximately 18 μA. Thus, the first transistor T₁ is turned off, so that there is little voltage applied to the first port Port 1.

Next, a voltage of approximately 0 V is output during a period of approximately 10 ms through the second port Port2 of the BMU 110. Accordingly, the second transistor T₂ is turned off. Thus, the voltage of the positive electrode terminal B+ of the battery 100 is applied to the first port Port1 through the first transistor T₁.

As described above, if the BMU 110 is supplied with constant voltage from the battery 100, the operations of the first and second transistors T₁ and T₂ are controlled by the output signal of the second port Port2. Therefore, if the aforementioned operations are continuously repeated, the effect of applying a substantially constant voltage to the first port Port1 may be generated. It may be preferable to set the period of the output signal of the second port Port2 to be sufficiently short to apply a substantially constant voltage to the first port Port1.

Hereinafter, a charge and discharge system of a battery pack according to still another embodiment of the present invention is described. The charge and discharge system according to the illustrated embodiment is different from the charge and discharge system according to the previous embodiment shown in FIGS. 1 and 2 in view of the operation of a second port of a BMU being disenabled and the configuration of a wake up unit. The illustrated BMU is substantially the same as that shown in FIGS. 1 and 2. The following description focuses on the configuration of a wake up unit.

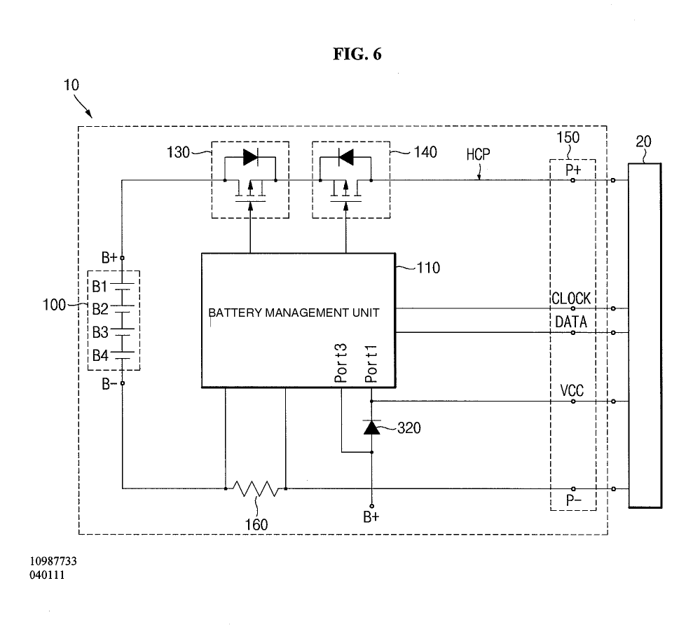

FIG. 6 is a block diagram of a charge and discharge system in a battery pack according to still another embodiment. Referring to FIG. 6, the charge and discharge system comprises a BMU 110 and a wake up unit 320. The BMU 110 comprises a first port Port1, and is capable of controlling charging and discharging of the battery 100.

The illustrated BMU is substantially the same as that of the embodiment shown in FIG. 2 except that the illustrated BMU 110 has a second port disenabled. The wake up unit 320 allows a wake-up voltage to be continuously applied to a first port Port1 of the BMU 110. The wake up unit 320 comprises a diode connected between a positive electrode terminal B+ of a battery and the first port Port1. The diode has an anode terminal electrically connected to the positive electrode terminal B+ of the battery and a cathode terminal electrically connected to the first port Port1. The wake up unit 320 allows a voltage to be constantly applied to the first port Port1 using the diode connected between the positive electrode terminal B+ and the first port Port1.

Although exemplary embodiments have been described for illustrative purposes, those skilled in the art will appreciate that various modifications, additions and substitutions are possible, without departing from the scope and spirit of the invention.

What is claimed is:

1. A system configured to charge and discharge a battery pack, the system comprising:
a battery management unit comprising:
a first port configured to receive a wake up voltage, and
a second port configured to output a control voltage,
wherein the battery management unit is configured to control charging and discharging of the battery pack; and
a wake up unit configured to apply the wake up voltage to the first port, wherein the wake up unit comprises:
a first transistor comprising a control electrode, a first electrode connected to a positive terminal of the battery, and a second electrode connected to the first port of the battery management unit; and
a second transistor comprising a control electrode connected to the second port of the battery management unit, a first electrode connected to the ground, and a second electrode connected to the control electrode of the first transistor.

2. The system of claim 1, wherein the control voltage is a constant voltage having a predetermined level.

3. The system of claim 1, further comprising a first resistor connected between the first electrode and the control electrode of the first transistor.

4. The system of claim 3, further comprising a second resistor connected between the control electrode of the first transistor and the second electrode of the second transistor.

5. The system of claim 1, wherein the first transistor comprises a p-type metal oxide semiconductor field effect transistor (MOSFET) and the second transistor comprises an n-type MOSFET.

6. The system of claim 1, wherein the wake up voltage applied by the wake up unit is greater than a wake up threshold.

7. The system of claim 1, wherein the control voltage is periodic.

8. The system of claim 1, wherein the control voltage comprises a square wave.

9. The system of claim 8, wherein the wake up voltage applied by the wake up unit changes and is sometimes greater than a wake up threshold and sometimes less than the wake up threshold.

10. A system configured to charge and discharge a battery pack, the system comprising:
a battery management unit comprising:
a first port configured to receive a wake up voltage, and
a second port configured to output a control voltage,
wherein the battery management unit is configured to control charging and discharging of the battery pack; and
a wake up unit configured to apply the wake up voltage to the first port, wherein the wake up unit comprises:
a first transistor comprising a first electrode connected to the first port of the battery management unit, a second electrode connected to a positive electrode terminal of the battery, and a control electrode; and
a second transistor comprising a first electrode connected to the ground, a second electrode connected to the control electrode of the first transistor, and a control electrode connected to the second port of the battery management unit.

11. The system of claim 10, wherein the control voltage is a constant voltage having a predetermined level.

12. The system of claim 10, further comprising a first resistor connected between the second electrode of the first transistor and the second electrode of the second transistor.

13. The system of claim 12, further comprising a second resistor connected between the control electrode of the first transistor and the second electrode of the second transistor.

14. The system of claim 13, further comprising third and fourth resistors connected in series between the control electrode of the second transistor and the second port of the battery management unit.

15. The system of claim 14, further comprising a fifth resistor and a capacitor connected in parallel between each of connection nodes of the third and fourth resistors and the ground.

16. The system of claim 10, wherein the first transistor and the second transistor comprise a bipolar junction transistor.

17. The system of claim 10, wherein the wake up voltage applied by the wake up unit is greater than a wake up threshold.

18. The system of claim 10, wherein the battery management unit outputs constant signals periodically through the second port.

19. The system of claim 10, wherein the control voltage comprises a square wave.

20. The system of claim 19, wherein the wake up voltage applied by the wake up unit changes and is sometimes greater than a wake up threshold and sometimes less than the wake up threshold.

21. A system configured to charge and discharge a battery pack, the system comprising:
a battery management unit comprising a first port configured to receive a wake up voltage, wherein the battery management unit is configured to control charging and discharging of the battery pack; and
a wake up unit configured to apply the wake up voltage to the first port, wherein the wake up unit comprises a diode connected between a positive electrode terminal of the battery and the first port.

22. A system configured to charge and discharge a battery pack, the system comprising:
a battery management unit comprising:
a first port configured to receive a wake up voltage, and
a second port configured to output a control voltage,
wherein the battery management unit is configured to control charging and discharging of the battery pack; and
a wake up unit configured to apply the wake up voltage to the first port while the system is operating,
wherein when the voltage supplied by the battery pack drops to less than a predetermined level, the battery management unit is configured to stop outputting the control voltage ant the second port, and
wherein the input of the wake up voltage causes the battery management unit to restart outputting the control voltage at the second port after the outputting of the control voltage has been stopped.
